(19) United States
(12) Patent Application Publication
(10) Pub. No.: US 2024/0246067 A1
(43) Pub. Date: Jul. 25, 2024

(54) HIGHLY DISPERSED PALLADIUM CATALYSTS

(71) Applicant: JOHNSON MATTHEY PUBLIC LIMITED COMPANY, London (GB)

(72) Inventors: Ekaterina Krasteva NOVAKOVA-GREEN, Royston (GB); Stephen Gary WAINWRIGHT, Billingham (GB)

(21) Appl. No.: 18/561,594

(22) PCT Filed: Jul. 11, 2022
(86) PCT No.: PCT/GB2022/051782

§ 371 Date: Nov. 16, 2023

(30) Foreign Application Priority Data
Jul. 12, 2021 (GB) 2109994.0

(51) Int. Cl. B01J 37/02; B01J 21/04; B01J 23/44; B01J 35/30; B01J 35/50; B01J 35/61; B01J 37/00; B01J 37/18

(52) U.S. Cl. CPC B01J 37/0203; B01J 21/04; B01J 23/44; B01J 35/392; B01J 35/394; B01J 35/397; B01J 35/50; B01J 35/615; B01J 37/0018; B01J 37/0213; B01J 37/0236; B01J 37/18

(57) ABSTRACT

The invention relates to catalysts comprising palladium on a support in which the palladium is distributed in the support as an eggshell. The palladium surface area is at least 150 m²/gPd. A method for manufacturing such catalysts involves impregnating a support with an impregnation solution comprising palladium ions and citrate ions, followed by drying the resulting product. Also described is an impregnation solution comprising palladium ions, citric and/or citrate ions, and acetic acid, which is suitable for manufacturing the catalysts described.

### FIELD OF THE INVENTION

The present invention relates to palladium catalysts for hydrogenation.

### BACKGROUND

Palladium is widely used for hydrogenation reactions. Palladium hydrogenation catalysts are commonly manufactured by impregnating a support with a solution of a palladium salt, followed by drying and then reduction to form the active metal species. Commercially available palladium salts include palladium chloride, palladium nitrate and palladium acetate.

WO2010/032051 (Johnson Matthey PLC) describes catalysts comprising Pd and/or Pt, and a second metal selected from Ru, Co and/or Mn. In the examples, catalysts comprising Pd and Ru are prepared by impregnating a support of alumina spheres with an aqueous solution of a Pd or Ru salt. Nitrate salts are used as the source of metal in the examples.

Palladium is a highly expensive metal and the palladium salt used in the impregnation step is a significant expense in the catalyst manufacturing process. For this reason, it is important that as much of the metal as possible is in an active form, i.e. accessible to the feed molecules rather than being present in the bulk. In practice, this means that the palladium particles (sometimes called crystallites) within the catalyst should be small so as to maximise available metal surface area. In addition, the distribution of palladium across the support is usually controlled so that it is only present in a layer at the surface of the support which the feed molecules have access to; this layer of metal is referred to in the art as an “eggshell”.

There is a need to reduce the amount of palladium used and/or increase the catalyst activity without increasing metal content. One way of achieving this would be to increase the active surface area of palladium in the catalyst. This could be achieved by one or more of: reducing the average size of palladium particles in the active catalyst, and/or (in the case of eggshell catalysts) decreasing the thickness of the eggshell. The present invention addresses this problem.

### DESCRIPTION OF THE FIGURES

FIG. 1 is a photograph of a cross-section of a catalyst prepared using palladium citrate (E7).

FIG. 2 is a photograph of a cross-section of a catalyst prepared using a solution containing palladium nitrate+citric acid (CE8).

### SUMMARY OF INVENTION

The present inventors have found that, surprisingly, the use of palladium citrate as the palladium source during the impregnation step results in eggshell catalysts having a very high metal surface area. To the inventors' best knowledge, the use of palladium citrates as sources of palladium has not been widely explored.

In hindsight after having made the invention, the inventors found that there were some isolated examples using a solution comprising a metal ion and citric acid or a citrate salt as an impregnation solution.

JPS54136589 (Toyota Motor Co Ltd) describes a method for producing a catalyst by immersing a carrier in a solution obtained by adding ammonium citrate to palladium nitrate.

The reference explains that it is important to use ammonium citrate rather than citric acid because the former is able to complex palladium even when the pH is low and thereby prevent palladium salt from precipitating at low pH. While the result is a catalyst with a thin layer of palladium at the surface of the catalyst (i.e. an eggshell), there is no discussion about metal dispersion.

CN102284295A (China Petroleum & Chemical et al) describes hydrogenation catalysts which are prepared using an impregnation solution comprising a water-soluble Group VIB metal (Cr, Mo and W) compound, a water-soluble group VIII metal (Ni, Co, Pd, Rh, Ru and Fe) organic acid salt and a water-soluble organic additive. The presence of the organic acid is proposed to form a complex with the Group VIB and VIII metals and in turn, for reasons which are not fully understood, leads to an increase in dispersion of the metals. The invention is exemplified by carrying out an impregnation of a molecular sieve with an aqueous impregnation solution comprising either (1) nickel citrate (formed in situ from nickel carbonate and citric acid), citric acid, ammonium metatungstate and glycerine; (2) nickel acetate (formed in situ from nickel carbonate and acetic acid), ammonium metatungstate and glycerine; or (3) nickel formate (formed in situ from nickel carbonate and formic acid), ammonium metatungstate and polyethylene glycol. While CN102284295A demonstrates that highly dispersed Wand Ni can be formed on a support using a complexing agent such as citric acid, there is no evidence that the same effect is achieved with Pd.

CN103769088A (Hainan University) describes the preparation of a Pd/C catalyst by the steps of: (1) treating a carbon support with nitric acid; (2) preparing an impregnation solution comprising palladium chloride dissolved in dilute hydrochloric acid; (3) adding the activated carbon to an aqueous solution of sodium citrate, ultrasonically shaking and then adding the solution from (2); (4) isolating the catalyst.

CN104475092A (Guizhou University) describes a palladium catalyst for the synthesis of hydrogen peroxide. A process for manufacturing the catalyst involves impregnating an alumina carrier with a solution containing PdCl₂, HCl and a competitive adsorbent. In an example citric acid is used as the competitive adsorbent.

CN111085193A (China Petroleum) describes a method of producing a catalyst using an impregnation solution including a palladium-containing compound and an inorganic acid and/or organic acid. The inorganic acid is hydrochloric and/or nitric acid. The organic acid is one or more of citric acid, fumaric acid, formic acid, acetic acid, propionic acid, malonic acid and butyric acid. By using this combination of acids the concentration of palladium at the surface of the catalyst is reduced, and the amount of palladium lost through dusting is thereby decreased.

WO2010/032051 (Johnson Matthey) describes catalysts comprising platinum, palladium or a mixture of palladium and platinum, and at least one further metal selected from ruthenium, cobalt and manganese. The catalysts can be used for the oxidation of organic compounds in a gas stream. A general procedure for preparing the catalysts involves depositing a compound of the metal in or on a support material followed by reducing the metal compound to the elemental form. Various salts are suggested including metal citrate, although this is not exemplified. The sources of metals used in the examples are nitrates or nitrosyl nitrates.

WO2020/256058 (Cataler Corporation) describes a catalyst for purifying methane comprising palladium and/or palladium oxide on an alumina carrier. The catalysts can be prepared by precipitating palladium and/or palladium oxide onto the carrier using a solution containing a palladium source and a polyvalent carboxylic acid. The role of the polyvalent carboxylic acid is postulated to prevent aggregation of the palladium or palladium oxide crystals such that they are deposited in a fine and crystalline manner. Example 5 describes the use of an impregnation solution prepared by adding citric acid to aqueous palladium nitrate.

As the examples of the present application will demonstrate, it is not possible to produce catalysts with palladium dispersions of at least 150 m²/g_{Pd} by using an impregnation prepared simply by combining a palladium salt and citric acid in aqueous solution. To achieve high dispersions it is necessary to ensure formation of the palladium citrate complex, either by dissolving palladium citrate solid in solution or by combining a palladium salt and citric acid in solution and heating the mixture for a sufficient time and duration to form the palladium citrate complex. Furthermore, using an impregnation solution prepared by combining a palladium salt and citric acid, without heat treatment, resulted in uniform distribution of palladium rather than an eggshell. None of the above references describe a distinct step of preparing palladium citrate and therefore none of the examples would be expected to have a palladium surface area of at least 150 m²/g_{Pd}.

In a first aspect the invention relates to a method for preparing a supported palladium catalyst, comprising the steps of:
(i) impregnating a support with an impregnation solution comprising palladium ions and citrate ions; and
(ii) drying the product of step (i); wherein
the impregnation solution used in step (i) is free of Group VIB metals;
the supported palladium catalyst has a palladium surface area of at least 150 m²/g_{Pd} as measured by carbon monoxide chemisorption;
the palladium is distributed in the support as an eggshell; and
the catalyst is free of Group VIB metals.

The catalyst produced after step (ii) is sometimes referred to in the art as being “oxidic”. It will be appreciated that before use the oxidic catalyst must be activated by reducing the palladium ions to metal (step (iii)). This may be carried out by the catalyst manufacturer or may be carried out in situ in the reactor in which the catalyst is to be used.

In a second aspect the invention relates to a catalyst obtained by the method of the first aspect. This includes both oxidic catalysts (obtained after step (ii)) or reduced catalysts (obtained after step (iii)).

In a third aspect the invention relates to a catalyst comprising palladium on a support, wherein:
the catalyst has a palladium surface area of at least 150 m²/g_{Pd} as measured by carbon monoxide chemisorption;
the palladium is distributed in the support as an eggshell; and
the catalyst is free of Group VIB metals.

The catalysts according to second and third aspects are particularly suitable for hydrogenation reactions due to their high metal surface area.

In a fourth aspect the invention relates to an impregnation solution comprising palladium ions, citric acid and/or citrate ions, and acetic acid, in which at least a portion of the palladium is in the form of palladium citrate.

### Terminology

“Catalyst” means an oxidic catalyst or a reduced catalyst unless context requires otherwise.

“Oxidic catalyst” means a catalyst in which the majority of the palladium is in a positive oxidation state.

“Reduced catalyst” means a catalyst in which the majority of the palladium is in oxidation state 0.

“Group VIB metal” means Cr, Mo or W.

### DETAILED DESCRIPTION

Any sub-headings are included for convenience only, and are not to be construed as limiting the disclosure in any way.

### Manufacturing Method

### Step (i)

Step (i) is an impregnation step carried out on a catalyst support. The skilled person will appreciate that the shape of the catalyst particles may depend on the end use of application. Factors which dictate the shape of catalyst used include: required surface area, required crush strength and acceptable pressure drop in the reactor. Preferred shapes for the support include spheres, pellets, cylinders and multilobe shaped (e.g. trilobe or tetralobe shapes). A particularly preferred shape is a trilobe as this shape offers a good balance of high surface area, good crush strength and low reactor pressure drop.

The support may be any material which is inert under the end use of the catalyst. Preferred materials include activated carbon, silica, alumina and silica-alumina. Alumina is a particularly preferred support. As those skilled in the art will know, alumina comes in a variety of different forms (α-alumina, γ-alumina, δ-alumina, θ-alumina, etc. . . . ), any of which may be used in the invention.

Impregnation is well known in the art for producing supported catalysts. Impregnation is carried out by adding a solution containing the metal to be impregnated to the support.

In one embodiment the impregnation solution is prepared by dissolving palladium citrate in deionized water. This has the advantage that the solution is free of other ions besides palladium and citrate, and may be preferred when catalyst purity is important. However, palladium citrate is not currently available commercially.

Alternatively, the impregnation solution may be prepared by dissolving a palladium salt (other than palladium citrate) and citric acid or a citrate salt, preferably citric acid, in deionized water and heating the mixture for a sufficient time and duration to form the palladium citrate complex. This has the advantage that less expensive palladium salts may be used in place of palladium citrate. A wide variety of palladium salts can be used but palladium nitrate, palladium chloride and palladium acetate are preferred because they are commercially available. Palladium acetate is preferred. The citric acid or citrate salt is preferably in excess, preferably 1 to 2 molar equivalents of citric acid or citrate salt are used per mole of palladium, e.g. 1 to 1.5 molar equivalents or 1 to 1.2 molar equivalents. The temperature and duration of the treatment may depend on scale but typically heating at a temperature of 65-85° C. for a duration of at least 1 hour, such as 4-8 hours, is sufficient to form the palladium citrate. Palladium citrate shows a characteristic UV absorbance at 388 nm which can be used as a guide as to whether the complex has formed.

Whichever method is used to prepare the impregnation solution, it is a requirement that the impregnation solution is free of Group VIB metal ions (Cr, Mo, W. The term “free of” as used herein means that if any Group VIB metal ion(s) are present, then the molar ratio of palladium:Group VIB metal ion(s) is 1:≤0.1. Preferably the ratio of palladium:Group VIB metal ion(s) is preferably 1:≤0.05, preferably 1:≤0.01.

It is preferred that the only metal present in the impregnation solution is palladium.

Impregnation may be carried out in any suitable mixer, but is preferably carried out in a tumbler mixer. Preferably the volume of impregnation solution used in step (i) is less than the absorption volume of the support, in order to ensure full take-up of the solution by the support. The impregnation solution may be added to the support in one go, or may be added portion wise.

### Step (ii)

Following step (i) the product is dried in order to remove water. Drying conditions will readily be determined by those skilled in the art. Exemplary conditions are treatment of the product from step (i) at 105° C. for 12 h.

The resulting catalyst after step (ii) is referred to as an oxidic catalyst and comprises Pd in the positive oxidation state.

Step (iii)

The dried product formed in step (ii) may be reduced so that the palladium salt is converted into the active form of palladium(0). This may be achieved by any means known to those skilled in the art, such as by reduction using hydrazine or reduction using H₂.

A preferred method involves using a mixture of H₂ in an inert diluent such as N₂ or Ar, preferably N₂. This method involves gradually heating the catalyst up to a sufficient temperature to achieve reduction. A particularly preferred method involves heating the material up to a temperature of around 320° C. at a ramp rate of around 5° C./min in 5:95 H₂/N₂, then holding at 320° C. for 2 hours.

Once reduced, the catalyst should be stored under an inert atmosphere.

In a second aspect the invention relates to a catalyst obtained or obtainable by the method according to the first aspect.

### Catalyst

In a third aspect the invention relates to a catalyst comprising palladium on a support, wherein the catalyst has a palladium surface area of at least 150 m²/g_{Pd} as measured by carbon monoxide chemisorption, the palladium is distributed in the support as an eggshell, and wherein the catalyst is free of Group VIB metals.

Palladium surface area reported herein is measured by carbon monoxide chemisorption according to the method described in the examples section. The catalyst has a palladium surface area of at least 150 m²/g_{Pd}. Preferably the palladium surface area is 150 to 250 m²/g_{Pd}, such as 160 to 220 m²/g_{Pd} or 170 to 210 m²/g_{Pd}.

The catalyst preferably comprises palladium in an amount of 0.1 to 5 wt % based on the total weight of catalyst. An advantage of the present invention is that the higher surface area made possible by the method allows the palladium loading to be reduced while maintaining a given catalyst activity. It is preferred that the catalyst comprises palladium in an amount of 0.1 to 2 wt %, such as 0.1 to 1.5 wt %.

The palladium is distributed in the support as an eggshell, meaning that the palladium is not evenly distributed throughout the support, but is concentrated towards the surface of the support. This has the advantage that the active metal is accessible to molecules in the feed. A palladium eggshell can be formed by following the method according to the first aspect of the invention.

The catalyst is free of Group VIB metal ions (Cr, Mo, W. “Free of” as used herein means that, if any Group VIB metal ion(s) are present, then the molar ratio of palladium:Group VIB metal ion(s) in the catalyst is 1:≤0.1. Preferably the ratio of palladium:Group VIB metal ion(s) is 1:≤0.05, preferably 1:≤0.01.

The support is preferably one described previously in the context of the method. A preferred support is alumina, preferably θ-alumina.

The catalyst is preferably in the form of pellets, cylinders or trilobes, most preferably trilobes.

In a particularly preferred embodiment the catalyst comprises palladium on a support,
wherein the catalyst has a palladium surface area of 160 to 220 m²/g_{Pd};
the catalyst comprises palladium in an amount of 0.5 to 1.5 wt %;
the support is an alumina trilobe; and
the palladium is distributed in the support in the form of an eggshell.

### Impregnation Solution

In a further aspect the invention relates to an aqueous impregnation solution comprising palladium ions, citric acid and/or citrate ions, and acetic acid, in which at least a portion of the palladium is in the form of palladium citrate. Such impregnation solutions are useful for preparing the catalysts described herein.

It is preferred that the impregnation solution consists essentially of palladium ions, citrate ions and/or citric acid, acetic acid and water. At least some of the palladium ions are complexed in the form of palladium citrate.

Depending on how many equivalents of citric acid or a citrate salt are used during preparation of the impregnation solution, some free citric acid/citrate ions may remain in solution.

The impregnation solution can be prepared by combining palladium acetate and citric acid or a citrate salt, preferably citric acid, in deionized water and heating the mixture for a sufficient time and duration to form the palladium citrate complex. Preferred conditions are described under the “step (i)” heading. Acetic acid is formed as a by-product of the reaction between palladium acetate and citric acid.

In a preferred embodiment the solution is prepared by combining palladium acetate with 1 to 4 molar equivalents of citric acid or a citrate salt, preferably citric acid, in deionized water. The resulting aqueous impregnation solution comprises 1 to 4 molar equivalents of citric acid and/or citrate per mole of palladium.

The invention includes the following embodiments.
1. A method for preparing a supported palladium catalyst, comprising the steps of:
(i) impregnating a support with an impregnation solution comprising palladium ions and citrate ions; and
(ii) drying the product of step (i);
wherein the impregnation solution used in step (i) is free of Group VIB metals.
2. A method according to embodiment 1, comprising a step (iii) of reducing the product of step (ii).
3. A method according to embodiment 2, wherein step (iii) is carried out in an atmosphere comprising a mixture of H₂ and N₂.
4. A method according to any of embodiments 1 to 3, wherein the impregnation solution in step (i) is prepared by dissolving palladium citrate solution in deionized water.
5. A method according to any of embodiments 1 to 3, wherein the impregnation solution in step (i) is prepared by dissolving a palladium salt and citric acid or a citrate salt in deionized water.
6. A method according to any of embodiments 1 to 5, wherein the volume of impregnation solution used in step (i) is less than the absorption volume of the support.
7. A method according to any of embodiments 1 to 6, wherein step (i) is carried out in a tumbler mixer.
8. A catalyst obtained by the method according to any of embodiments 1 to 7.
9. A catalyst comprising palladium on a support, wherein:
the catalyst has a palladium surface area of at least 150 m²/g_{Pd} as measured by carbon
monoxide chemisorption; and the catalyst is free of Group VIB metals.
10. A catalyst according to embodiment 9, wherein the catalyst has a palladium surface area of 150 to 250 m²/g_{Pd} as measured by carbon monoxide chemisorption.
11. A catalyst according to any of embodiments 9 to 10, wherein the palladium content is 0.1 to 2 wt % based on the total weight of catalyst.
12. A catalyst according to any of embodiments 9 to 11, wherein the support is in the form of pellets, cylinders or trilobes.
13. A catalyst according to any of embodiments 9 to 12, wherein the support is alumina.
14. A catalyst according to any of embodiments 9 to 13, wherein the support is an alumina trilobe.
15. A catalyst according to embodiment 9, wherein:
the catalyst has a palladium surface area of 160 to 220 m²/g_{Pd} as measured by carbon monoxide chemisorption;
the catalyst comprises palladium in an amount of 0.5 to 1.5 wt %;
the support is an alumina trilobe; and
the palladium is distributed in the support in the form of an eggshell.

### EXAMPLES

The invention will now be illustrated by the following non-limiting examples.

### Carbon Monoxide Chemisorption

Palladium metal areas were measured on a Micromeritics HTP 6 Station Chemisorption Analyser by a static (barometric) method.

The samples were prepared as follows. Approximately 1 g to 2 g of sample was used. The samples were initially heated to 140° C. at 10° C./minute in 100% helium flowing at 50 SCCM and held at 140° C. for 30 minutes. The helium was then switched off and the sample allowed to cool to 35° C. whilst under vacuum. The sample was then heated to 100° C. at 10° C./minute in 100% flowing hydrogen at 50 SCCM and held at 100° C. for 120 minutes to reduce the Pd. After the reduction stage is finished the hydrogen is switched off and the sample evacuated to less than 10 μmHg at 100° C. for 60 minutes. The sample is then cooled under vacuum to 35° C. and evacuation continued for a further 10 minutes under a vacuum of less than 10 μmHg. A leak test is then carried out prior to analysis. An acceptable leak rate is less than 5 μmHg/minute.

Metal area analysis is carried out at 35° C. and the sample is dosed with 100% carbon monoxide over a range of pressures between 100 and 760 mmHg. At each pressure the chemisorbing carbon monoxide is allowed to equilibrate, and the volume of gas uptake is measured and recorded automatically. Pressure/uptake pairs constitute a chemisorption isotherm. At the end of the analysis the sample is discharged, and the reduced weight of sample is recorded.

The volume of carbon monoxide adsorbed at a notional pressure of 0 mmHg (Oₜₒₜ) is calculated from the isotherm by extrapolating the linear portion of the chemisorption isotherm to pressure=0. Typically values between 100 and 400 mmHg give a good straight line fit. The software calculates Pd metal area based on 0ₜₒₜ.

### Preparation of Palladium Citrate

Method A: Solid palladium acetate (6.33 g) was charged to a round bottom flask and 1.1 molar equivalents of citric acid (6.51 g) dissolved in 50 ml water was added. The mixture was heated at 75° C. for 6 hr until complete dissolution. This gave a resulting deep red solution. The solution was filtered using 542 filter paper to remove any remaining solid impurities. ICP (Inductively Coupled Plasma analysis) gave a Pd assay of 5.73 wt % Pd.

Method B: Solid palladium acetate and 1.1 molar equivalents of citric acid were dissolved in water to form a slurry. The slurry was heated to 75° C. for approximately 2 hours to give a deep red solution, which was then cooled to room temperature and filtered.

### Example 1 (Comparative)

Alumina trilobes (1.2 mm, pore volume approx. 0.81 cm³/g, 99.0 g) were loaded into a tumbler. An impregnation solution was prepared by diluting sodium tetrachloropalladate solution (1.0 g as Pd Johnson Matthey) with deionized water (up to 200 mL). The impregnation solution was added over approximately 2 minutes to the tumbler mixer with gentle rotation (approximately 2 rpm) and the mixture was allowed to tumble for a further 15 mins (approximately 2 rpm). 7.5% Hydrazine hydrate solution (10 mL) was added to the tumbler mixer and the mixture was allowed to tumble for a further 30 minutes (approximately 2 rpm). Any excess impregnation solution was drained from the catalyst and the catalyst washed with deionized water (3 times 200 ml), the impregnated pellets were transferred to an oven and dried overnight at 105° C. The resulting catalyst had the following properties:

| | Pd assay | Metal area |
|---|---|---|
| Example | (wt %) | (m²/g_{Pd}) |
| CE1 | 1.01 | 62.3 |

### Example 2 (Comparative)

Alumina trilobes (1.5 mm, pore volume approx. 0.25 cm³/g, 99.0 g) were loaded into a tumbler. An impregnation solution was prepared by diluting palladium nitrate (1.0 g as Pd, Johnson Matthey) in deionized water (to the absorption volume of the support). The impregnation solution was added over approximately 2 minutes to the tumbler mixer with gentle rotation (approximately 2 rpm) and the mixture was allowed to tumble for a further 15 mins (approximately 2 rpm). The impregnated pellets were transferred to an oven and dried overnight at 105° C. The dried material was transferred to a tube furnace and was heated in a mixture of 5:95 H₂:N₂ with a ramp rate of 5° C./min up to a temperature of 320° C., then held at 320° C. for 2 hours. The heat was switched off and the furnace was allowed to cool under a flow of N₂. The resulting catalyst had a measured Pd metal area of 88.8 m²/gPd and Pd assay of 0.98 wt % Pd.

| | Pd assay | Metal area |
|---|---|---|
| Example | (wt %) | (m²/g_{Pd}) |
| CE2 | 0.98 | 88.8 |

### Examples 3-6

Alumina pellets (1.2 mm, pore volume approx. 0.81 cm³/g) were loaded into a tumbler. An impregnation solution was prepared by diluting palladium citrate solution (prepared using Method A above) with deionized water to the absorption volume of the support. The impregnation solution was added over approximately 2 minutes to the tumbler mixer with gentle rotation (approximately 2 rpm) and the mixture was allowed to tumble for a further 15 mins (approximately 2 rpm). The impregnated pellets were transferred to an oven (bed depth of catalyst 2-5 mm) and dried overnight at 105° C. The dried pellets were then reduced (5:95 H₂:N₂) following the same procedure as Example 2. The dried material was measured for Pd content and metal surface area.

| | Pd assay | Metal area |
|---|---|---|
| Example | (wt %) | (m²/g_{Pd}) |
| E3 | 0.29 | 201 |
| E4 | 0.52 | 206 |
| E5 | 0.67 | 188 |
| E6 | 0.92 | 190 |

Using palladium citrate as the source of palladium results in a higher palladium metal area than when conventional palladium salts (sodium tetrachloropalladate or palladium nitrate) are used. The metal area (m²/gPd) was relatively constant with changes in metal loading. Catalysts with higher metal surface area can be expected to be more active in a variety of reactions, such as hydrogenation.

### Example 7

Example 7 was prepared in the same way as examples 3-6 using the same alumina pellets (1.2 mm, pore volume approx. 0.81 cm³/g), except that palladium citrate was made according to Method B and the impregnated pellets were dried overnight at 120° C. instead of 105° C.

| | Drying | Pd assay | Metal area |
|---|---|---|---|
| Example | conditions | (wt %) | (m²/g_{Pd}) |
| E6 | 105° C. | 0.92 | 190 |
| | overnight | | |
| E7 | 120° C. | 0.94 | 182 |
| | overnight | | |

Drying temperature did not have a significant impact on metal area.

### Example 8 (Comparative)

Example 8 was prepared in the same way as Example 7 except that the solution of palladium citrate was replaced with a solution prepared by dissolving palladium nitrate and citric acid (molar ratio Pd:anhydrous citric acid of 1:1.1).

| | | Pd distri- | Drying | Pd assay | Metal area |
|---|---|---|---|---|---|
| Example | Pd salt | bution | conditions | (wt %) | (m²/g_{Pd}) |
| CE2 | Palladium | eggshell | 105° C. | 0.98 | 88.8 |
| | nitrate | | overnight | | |
| E6 | Palladium | eggshell | 105° C. | 0.92 | 190 |
| | citrate | | overnight | | |
| E7 | Palladium | eggshell | 120° C. | 0.94 | 182 |
| | citrate | | overnight | | |
| C8 | Palladium | homo- | 120° C. | 0.97 | 164 |
| | nitrate + | geneous | overnight | | |
| | citric acid | | | | |

C8 is representative of prior art methods in which a palladium salt and citric acid are used together without pre-forming the palladium citrate by a thermal treatment. While in the case of C8 the metal area was much higher than when palladium nitrate was used without citric acid (CE2), the metal area was not as high as when a heat treatment was carried out on the impregnation solution to form palladium citrate (E6 and E7). Furthermore, the use of palladium nitrate and citric acid together resulted in a homogeneous dispersion of palladium rather than an eggshell.

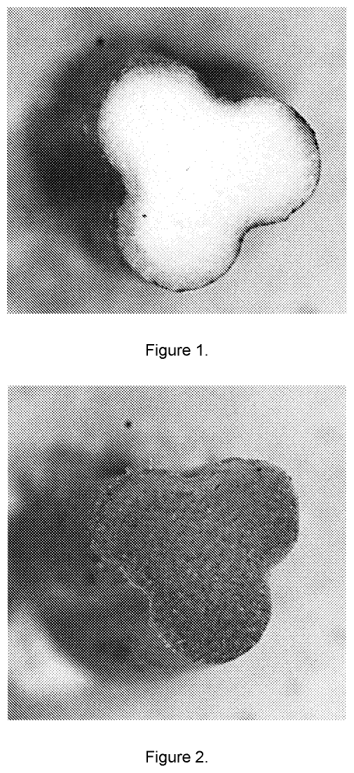

Cross-sections of catalysts E7 and CE8 are shown in FIGS. 1 and 2 respectively. E7 shows a tight eggshell whereas the palladium distribution in CE8 is uniform.

1. A method for preparing a supported palladium catalyst, comprising the steps of:
(i) preparing an impregnation solution by:
dissolving palladium citrate in deionized water; or
dissolving a palladium salt and citric acid in deionized water and heating the mixture at a temperature of 65-85° C. for a duration of at least 1 hour then impregnating an alumina trilobe support with an impregnation solution comprising palladium ions and citrate ions; and
(ii) drying the product of step (i); wherein
the impregnation solution used in step (i) is free of Group VIB metals;
the supported palladium catalyst has a palladium surface area of at least 150 m²/g_{Pd} as measured by carbon monoxide chemisorption;
the palladium is distributed in the support as an eggshell; and
the catalyst is free of Group VIB metals.

2. A method according to claim 1, wherein the supported palladium catalyst comprises the catalyst has a palladium surface area of at least 150 m²/g_{Pd} as measured by carbon monoxide chemisorption; the palladium is distributed in the support as an eggshell; and the catalyst is free of Group VIB metals.

3. A method according to claim 1, comprising a step (iii) of reducing the product of step (ii).

4. A method according to claim 3, wherein step (iii) is carried out in an atmosphere comprising a mixture of H₂ and N₂.

5-7. (canceled)

8. A method according to claim 1, wherein the impregnation solution is prepared by dissolving palladium acetate and citric acid in deionized water and heating the mixture at a temperature of 65-85° C. for a duration of 4-8 hours.

9. A method according to claim 1, wherein 1 to 2 molar equivalents of citric acid are used per mole of palladium.

10. A method according to claim 1, wherein the volume of impregnation solution used in step (i) is less than the absorption volume of the support.

11. A catalyst obtained by the method of claim 1.

12. A catalyst comprising palladium on an alumina trilobe support, wherein:
the catalyst has a palladium surface area of at least 150 m²/g_{Pd} as measured by carbon monoxide chemisorption;
the palladium is distributed in the support as an eggshell; and
the catalyst is free of Group VIB metals.

13. A catalyst according to claim 12, wherein the catalyst has a palladium surface area of 150 to 250 m²/g_{Pd} as measured by carbon monoxide chemisorption.

14. A catalyst according to claim 12, wherein the palladium content is 0.1 to 2 wt % based on the total weight of catalyst.

15-17. (canceled)

18. A catalyst according to claim 12, wherein:
the catalyst has a palladium surface area of 160 to 220 m²/g_{Pd} as measured by carbon monoxide chemisorption;
the catalyst comprises palladium in an amount of 0.5 to 1.5 wt %;
the support is an alumina trilobe; and
the palladium is distributed in the support in the form of an eggshell.

19. An aqueous impregnation solution comprising palladium ions, citric acid and/or citrate ions, and acetic acid, in which at least a portion of the palladium is in the form of palladium citrate.

20. An aqueous impregnation solution according to claim 19, wherein 1 to 2 molar equivalents of citric acid and/or citrate are present per mole of palladium.

21. An aqueous impregnation solution according to claim 19, wherein 1 to 1.2 molar equivalents of citric acid and/or citrate are present per mole of palladium.
